(19) United States
(12) Patent Application Publication
(10) Pub. No.: US 2019/0386834 A1
(43) Pub. Date: Dec. 19, 2019

(54) BLOCKCHAIN MANAGEMENT APPARATUS, BLOCKCHAIN MANAGEMENT METHOD, AND PROGRAM

(71) Applicant: NEC Corporation, Minato-ku, Tokyo (JP)

(72) Inventor: Ryo FURUKAWA, Tokyo (JP)

(73) Assignee: NEC Corporation, Minato-ku, Tokyo (JP)

(21) Appl. No.: 16/489,782

(22) PCT Filed: Mar. 3, 2017
(86) PCT No.: PCT/JP2017/008508

§ 371 Date: Aug. 29, 2019

(51) Int. Cl. H04L 9/32; G06F 21/64; G06Q 20/38

(52) U.S. Cl. CPC H04L 9/3247; G06F 21/64; H04L 2209/56; H04L 2209/38; G06Q 20/389

(57) ABSTRACT

A blockchain management apparatus includes: a block reception part that receives a block(s) including a transaction(s) including a contract(s), input to a contract(s), an execution result(s) of a contract(s), or the like; a transaction verification part including a contract signature verification section that verifies whether a signature(s) included in the transaction(s) included in the block(s) is a signature(s) of a guarantor(s) who closely examines and guarantees the contract(s) and a contract execution result verification section that verifies that the execution result(s) of the contract(s) included in the transaction(s) is accurate; a consensus building part that builds a consensus(es) about writing of the block(s) on a blockchain with a different blockchain management apparatus(es); and a ledger storage part that stores the block(s) about which the consensus(es) has been built.

### FIELD

The present invention relates to a blockchain management apparatus, a blockchain management method, and a program. In particular, it relates to a blockchain management apparatus, a blockchain management method, and a program having a contract verification function.

### BACKGROUND

In recent years, blockchains have been spread widely, one typical example of which is bitcoins (see NPL 1). On a blockchain, a peer-to-peer (P2P) network which does not need a central management server and in which anybody can participate is used, and all nodes participating this network can manage a shared ledger.

On a blockchain as typified by bitcoins, an individual blockchain management node participating management of the blockchain includes: ledger storage means for accumulating transactions issued by transaction issuers that issue history information (hereinafter referred to as transactions) accumulated on the blockchain; transaction verification means for verifying transactions; and consensus building means for equalizing the contents of the transactions accumulated among blockchain management nodes. Regarding the transactions accumulated in the individual ledger storage means, as a data structure, one or a plurality of transactions are grouped as a block, and an individual one of these blocks includes a hash value of its previous block.

A blockchain generally operates as follows. An individual blockchain management node receives one or a plurality of items of transaction information issued by one or a plurality of transaction issuers. Next, the transaction verification means performs verification, and only the verified transactions are aggregated. Since the aggregated transactions would differ among the individual blockchain management nodes, the consensus building means equalizes the accumulated transactions. One or a plurality of transactions equalized by the consensus building means among the individual blockchain management nodes are stored in the ledger storage means.

With this configuration and operation, even when a malicious node participates as a blockchain management node, it is difficult for the malicious node to perform falsification, and the same transactions among the individual blockchain management nodes are accumulated.

In the case of bitcoins, a virtual currency system is realized on a blockchain by managing a virtual currency payment history on individual ledgers.

### CITATION LIST

### Non Patent Literature

NPL 1: Satoshi. Nakamoto, “Bitcoin: A Peer-to-Peer Electronic Cash System”, 2009

### SUMMARY

### Technical Problem

The disclosure of the above literature is incorporated herein by reference thereto. The following analysis has been made by the present inventors.

The application of a blockchain is not limited to management of bitcoins. For example, by registering and accumulating a program, a hash value of a program, and input to and output from the program on a blockchain, the accuracy of an execution result of the program can be assured. This function is realized by open-source software referred to as Ethereum, for example. Assuring an execution result of a program by using such a blockchain as described above is referred to as a smart contract, and the program used in this case is referred to as a contract. In a smart contract, each time input to a contract is registered on a blockchain, an individual node managing the blockchain performs the contract. When an execution result of a contract is registered, the individual node performs verification on the execution result, and the consensus building means performs consensus building. Thus, only the accurate execution results are registered.

A smart contract assures accurate execution of a program. Thus, by making a contract as a program, a smart contract can be used for automatic enforcement of the contract, for example. For example, a smart contract is applicable to a case in which, when payment of virtual currency that satisfies a condition as input of a program is made, some right is automatically transferred to the payer.

However, a smart contract only assures what is written in a contract has been executed accurately. Thus, if an unintended operation is written by a bug or the like in a contract, a user that has invoked the contract experiences the unintended operation. As a result, the user could suffer a detriment, e.g., as a right managed on the blockchain could be stolen by another person. To avoid suffering such a detriment, the user has to examine the contract closely and verify whether the contract does not cause an unintended behavior. However, it is difficult for all the users to perform such verification, and it is not realistic to do so.

As described above, to use a smart contract safely, an individual one of the users needs to verify the contract and makes sure that no unintended operation is performed before using the smart contract. Thus, the verification costs required by the individual users are significantly large.

It is an object of the present invention to provide a blockchain management apparatus, a blockchain management method, and a program that enable individual users to use smart contracts safely without verifying contracts.

### Solution to Problem

According to a first aspect of the present invention, there is provided a blockchain management apparatus including: a block reception part that receives a block(s) including a transaction(s) including at least one of a contract(s), input to a contract(s), and an execution result(s) of a contract(s); a transaction verification part that verifies that the transaction(s) included in the block(s) is valid; a consensus building part that builds a consensus(es) about writing of the block(s) with a different blockchain management apparatus(es) when the transaction verification part has verified that the transaction(s) included in the block(s) is valid; and a ledger storage part that stores the block(s) about which the consensus(es) has been built; wherein the transaction verification part includes: a guarantor information storage section that stores a public key(s) of a guarantor(s) who assures security of a contract(s); a contract signature verification section that verifies, when the transaction(s) includes a contract(s), a signature(s) included in the transaction(s) by using a public key(s) of a guarantor(s) stored in the guarantor information storage section; and a contract execution result verification section that verifies that, when the transaction(s) includes an execution result(s) of a contract(s), the execution result(s) of the contract(s) included in the transaction(s) is accurate with respect to the corresponding contract(s) and corresponding input of the contract(s).

According to a second aspect of the present invention, there is provided a blockchain management method, including steps of: receiving a block(s) including a transaction(s) including at least one of a contract(s), input to a contract(s), and an execution result(s) of a contract(s); verifying that the transaction(s) included in the block(s) is valid; building a consensus(es) about writing of the block(s) with a different blockchain management apparatus(es) when the transaction(s) included in the block(s) has been verified as being valid; and storing the block(s) about which the consensus(es) has been built in a ledger storage part; wherein the step of verifying that the transaction(s) is valid includes steps of: verifying, when the transaction(s) includes a contract(s), a signature(s) included in the transaction(s) by using a public key(s) of a guarantor(s) stored in a guarantor information storage section that stores a public key(s) of a guarantor(s) who assures security of a contract(s); and verifying that, when the transaction(s) includes an execution result(s) of a contract(s), the execution result(s) of the contract(s) included in the transaction(s) is accurate with respect to the corresponding contract(s) and corresponding input of the contract(s).

According to a third aspect of the present invention, there is provided a program, causing a computer to execute processing for: receiving a block(s) including a transaction(s) including at least one of a contract(s), input to a contract(s), and an execution result(s) of a contract(s); verifying that the transaction(s) included in the block(s) is valid; building a consensus(es) about writing of the block(s) with a different blockchain management apparatus(es) when the transaction(s) included in the block(s) has been verified as being valid; and storing the block(s) about which the consensus(es) has been built in a ledger storage part; wherein the processing for verifying that the transaction(s) is valid includes: verifying, when the transaction(s) includes a contract(s), a signature(s) included in the transaction(s) by using a public key(s) of a guarantor(s) stored in a guarantor information storage section that stores a public key(s) of a guarantor(s) who assures security of a contract(s); and verifying that, when the transaction(s) includes an execution result(s) of a contract(s), the execution result(s) of the contract(s) included in the transaction(s) is accurate with respect to the corresponding contract(s) and corresponding input of the contract(s).

This program can be recorded in a computer-readable storage medium. The storage medium may be a non-transient storage medium such as a semiconductor memory, a hard disk, a magnetic storage medium, or an optical storage medium. The present invention may be embodied as a computer program product.

### Advantageous Effects of Invention

According to an individual aspect of the present invention, there are provided a blockchain management apparatus, management method, and program that enable individual users to use smart contracts safely without verifying contracts.

### BRIEF DESCRIPTION OF DRAWINGS

FIG. 1 is a block diagram illustrating an example of a blockchain management apparatus according to a first exemplary embodiment.

FIG. 2 is a flowchart illustrating an operation of the blockchain management apparatus according to the first exemplary embodiment.

FIG. 3 illustrates an example of a block received by a block reception part according to the first exemplary embodiment.

FIG. 4 illustrates examples of data stored in a ledger storage part according to the first exemplary embodiment.

FIG. 5 is a flowchart illustrating an operation of a transaction verification part according to the first exemplary embodiment.

FIG. 6 illustrates examples of public keys of a guarantor stored in a guarantor information storage section according to the first exemplary embodiment.

FIG. 7 is a flowchart illustrating an operation of a consensus building part according to the first exemplary embodiment.

FIG. 8 is block diagram illustrating an example of another blockchain management apparatus.

FIG. 9 is a block diagram illustrating an example of a hardware configuration of the blockchain management apparatus according to the first exemplary embodiment.

### DESCRIPTION OF EMBODIMENTS

First, an outline of an exemplary embodiment will be described. Reference characters in the following outline denote various elements for the sake of convenience and are used as examples to facilitate understanding of the present invention. Namely, the description of the outline is not intended to indicate any limitations. An individual connection line between blocks in an individual drawing signifies both one-way and two-way directions. An individual arrow schematically illustrates the principal flow of a signal (data) and does not exclude bidirectionality.

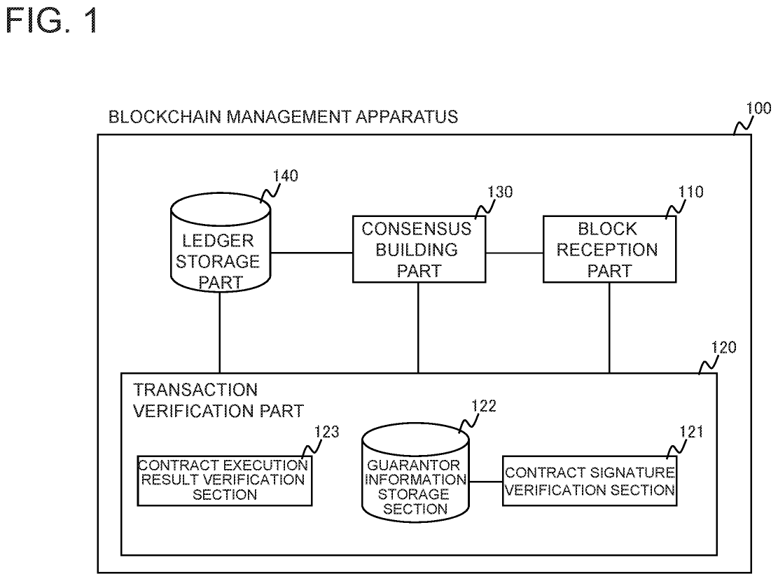

A blockchain management apparatus 100 according to an exemplary embodiment includes a block reception part 110, a transaction verification part 120, a consensus building part 130, and a ledger storage part 140 (see FIG. 1). The block reception part 110 receives a block(s) including a transaction(s) including a contract(s), input to a contract(s), and output from a contract(s) transmitted to a network of a blockchain. The transaction verification part 120 verifies that the transaction(s) included in the block(s) is valid. The consensus building part 130 builds a consensus(es) about whether to accumulate the received block(s) with a different blockchain management apparatus(es). The ledger storage part accumulates the block(s) about which the consensus building part has built a consensus(es). In addition, the transaction verification part 120 includes: a guarantor information storage section 122 that includes a public key(s) of a guarantor(s) who closely examines a contract(s) and guarantees that the contract(s) does not include an unintended operation(s); a contract signature verification section 121 that verifies that a signature(s) of a guarantor(s) is added to a contract(s); and a contract execution result verification section 123 that verifies that an execution result(s) of a contract(s) is accurate.

The blockchain management apparatus 100 according to the exemplary embodiment roughly operates as follows. First, the block reception part 110 receives a block(s) from a different blockchain management apparatus(es). Next, the transaction verification part 120 performs verification on all the transactions included in the block(s). In this verification, if a transaction is a contract, the contract signature verification section 121 verifies whether a signature of a guarantor has been added. If a contract is an execution result, the contract execution result verification section 123 verifies whether the contract has been executed accurately. If the verification results of all the transactions included in the block(s) are accurate, the block(s) is determined to be accurate. Next, the consensus building part 130 builds a consensus with a different node(s) and adds only the block(s) determined to be accurate in the ledger storage part 140.

In the disclosure of the present application, only the contracts closely examined by a guarantor(s) are determined to be accurate by the contract signature verification section 121, and only when all the transactions are accurate, the corresponding block(s) is stored in the ledger storage part 140. Thus, only the contracts closely examined by a guarantor(s) are stored in the ledger storage part 140. Thus, since it is guaranteed that all the available contracts have been verified by the guarantor(s), users of smart contracts can safely use the smart contracts without performing verification by themselves. Namely, the present invention provides a blockchain management apparatus having a smart contract function that can guarantees that, by using a blockchain that manages a shared ledger on a P2P network, an execution result(s) of a program(s) registered on the blockchain are accurate. In particular, the present invention provides a blockchain management apparatus that can guarantee that only the verified contracts are executed.

Hereinafter, an individual specific embodiment will be described in more detail with reference to drawings. In the exemplary embodiment, like reference characters refer to like constituent elements, and description thereof will be omitted.

### First Exemplary Embodiment

Next, a first exemplary embodiment will be described in detail with reference to drawings and based on specific examples. The individual drawings are used for describing an exemplary embodiment(s) of the present invention. However, the present invention is not limited to what is illustrated in the individual drawings. In the individual drawings, like reference numerals refer to like components, and redundant description thereof will be omitted as appropriate. In the drawings used in the following description, description of a configuration(s) of a portion(s) not related to the description of the present description will be omitted, and illustration of the configuration(s) will be omitted, as appropriate.

FIG. 1 is a block diagram illustrating an example of a configuration of a blockchain management apparatus 100 according to the first exemplary embodiment.

As illustrated in FIG. 1, the blockchain management apparatus 100 includes a block reception part 110, a transaction verification part 120, a consensus building part 130, and a ledger storage part 140. In addition, the transaction verification part 120 includes a contract signature verification section 121, a guarantor information storage section 122, and a contract execution result verification section 123.

The block reception part 110 is means adapted to receive a block including a transaction(s) which includes a hash value calculated from the last block and at least one of a contract expressed in code or binary, input to a contract, an execution result of a contract, and other arbitrary data.

The guarantor information storage section 122 is means adapted to store a public key(s) of a guarantor(s) who verifies that a contract does not cause an unintended operation. Namely, the guarantor information storage section 122 stores a public key(s) of a guarantor(s) who guarantees security of a contract.

The contract signature verification section 121 is means adapted to verify, when a transaction includes a contract, a signature added to the contract included in the transaction by using a public key(s) of a guarantor(s) stored in the guarantor information storage section 122.

The contract execution result verification section 123 is means adapted to verify that an execution result of a contract included in a transaction is accurate. Specifically, when a transaction includes an execution result of a contract, the contract execution result verification section 123 verifies the execution result of the contract included in the transaction is accurate with respect to the corresponding contract and corresponding input of the contract.

The consensus building part 130 is means adapted to build a consensus about whether to accumulate the received block with a different blockchain management apparatus(es). Specifically, when the transaction verification part 120 has verified that a transaction included in a block is valid, the consensus building part 130 builds a consensus about writing of the block with a different blockchain management apparatus(es). For example, the consensus building part 130 compares a hash value calculated from the received block in accordance with a predetermined rule with a target value given to the system or calculated from a plurality of blocks stored in the ledger storage part 140 and determines that, when the comparison result satisfies a predetermined condition, a consensus has been built with a different blockchain management apparatus(es).

The ledger storage part 140 is means adapted to accumulate blocks about which the consensus building part 130 has built a consensus(es).

Next, an operation of the blockchain management apparatus 100 will be described in detail based on specific examples.

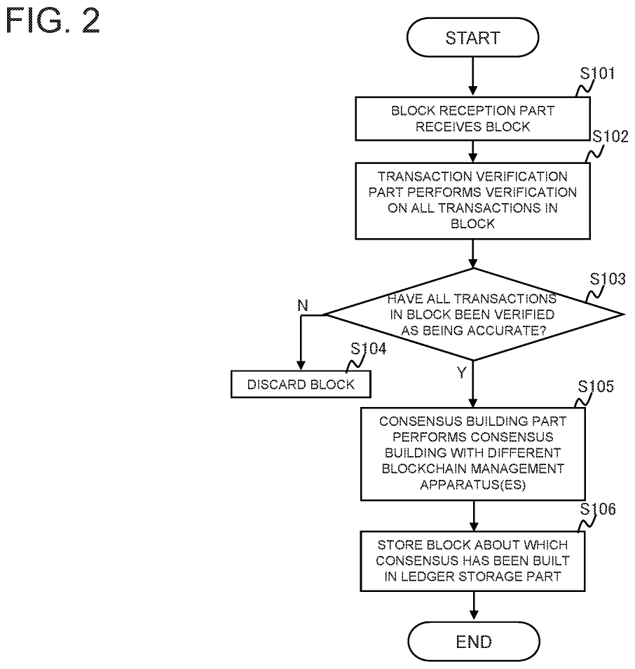

First, an operation of the blockchain management apparatus 100 will be described with reference to a flowchart in FIG. 2. In this operation, only the contracts guaranteed by a guarantor(s) are stored in the ledger storage part 140.

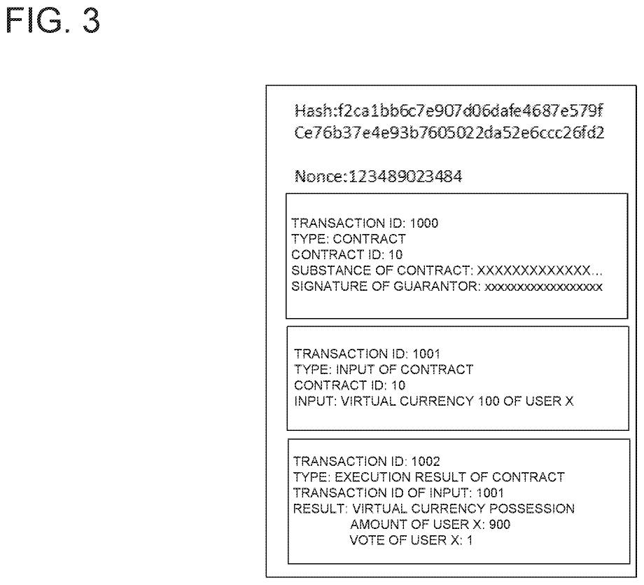

First, the block reception part 110 receives a block (step S101). This present example assumes that the block reception part 110 has received a block as illustrated in FIG. 3. This block includes a hash value of the last block, a value referred to as a nonce used by the consensus building part 130, and a group of transactions. The group of transactions includes a contract, input to the contract, and an execution result of the contract. In FIG. 3, each of the transactions includes a transaction ID (Identifier) determining the corresponding transaction, information determining a transaction type indicating whether the corresponding transaction is a contract, input of a contract, or an execution result of a contract, and the substance of the corresponding transaction.

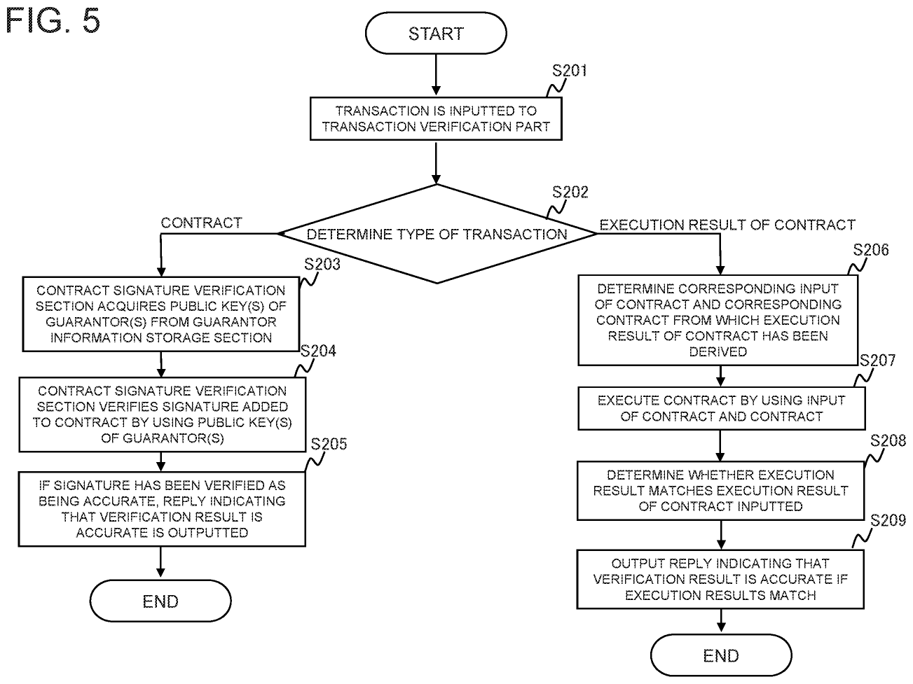

Next, the transaction verification part 120 performs verification on all the transactions included in the block (step S102). The content of the verification will be described below with reference to a flowchart in FIG. 5. This example assumes that the transaction verification part 120 has verified that all the transactions are accurate.

Next, the transaction verification part 120 determines whether all the transactions included in the block have been verified as being accurate (step S103). If all the transactions have been verified as being accurate, the processing proceeds to step S105. Otherwise, the processing proceeds to step S104.

If one or more of the transactions included in the block has been determined as being inaccurate as a result of the verification, the transaction verification part 120 discards the block (step S104).

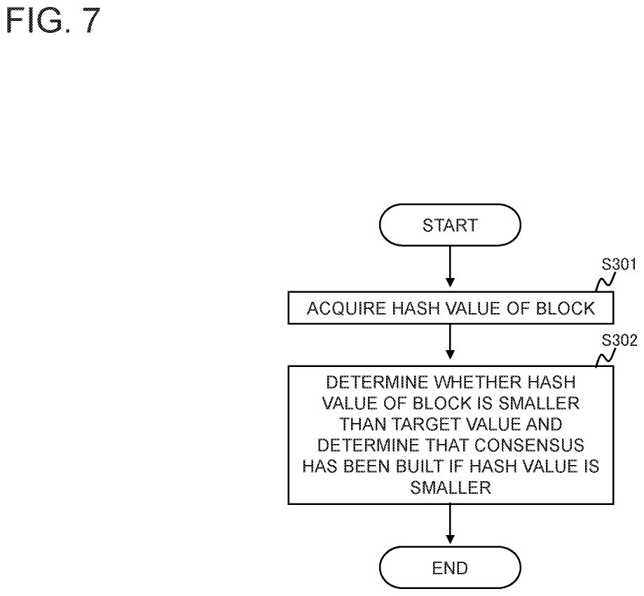

Next, if all the transactions included in the block have been determined as being accurate, the consensus building part 130 performs consensus building with a different blockchain management apparatus(es) 100 (step S105). How this consensus building is performed will be described below with reference to a flowchart in FIG. 7. In the above example, since all the transactions have been determined as being accurate, the consensus building part 130 performs step S105.

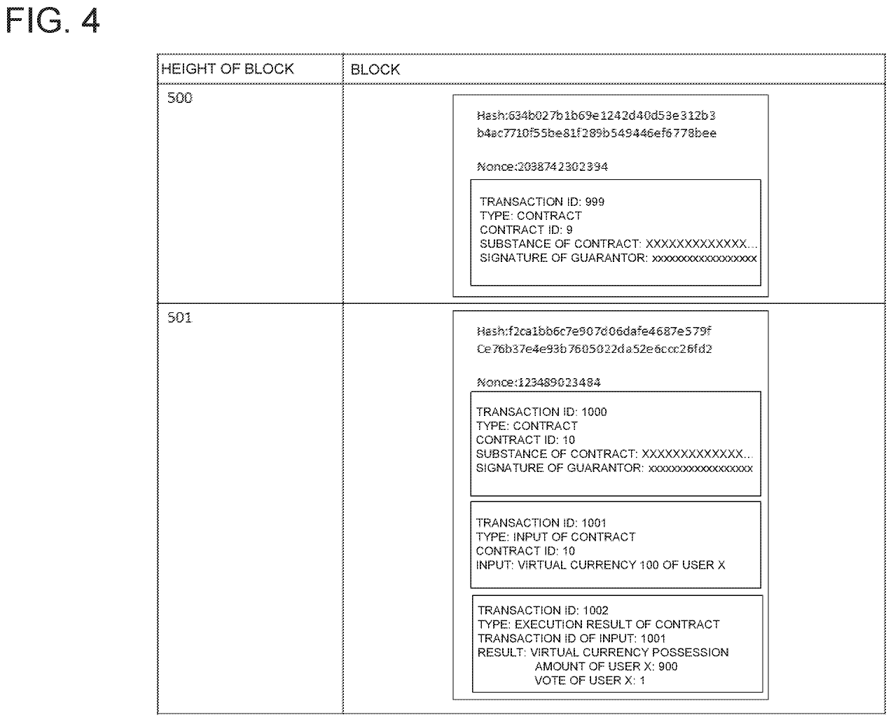

Finally, the consensus building part 130 stores the block about which a consensus has been built with the different blockchain management apparatus(es) 100 in the ledger storage part 140. In this example, the block is added in a ledger in the ledger storage part 140, as illustrated in FIG. 4. The ledger in FIG. 4 includes the heights and the main bodies of the blocks.

While a plurality of steps (processing) are described in an order in the flowchart used in the above description, the order of the execution of the steps is not limited to the above example. For example, steps S102 to S104 may be performed in a different order. For example, during step S105 in which the consensus building part 130 performs consensus building, step S102 in which the transaction verification part 120 performs verification on the transactions may be performed.

Next, step S102 in FIG. 2 will be described in detail with reference to a flowchart in FIG. 5. In step S102, the transaction verification part 120 performs verification on the transactions.

First, a verification target transaction is inputted to the transaction verification part 120 (step S201). In this example, for example, an individual one of the three transactions included in the block illustrated in FIG. 3 is inputted.

Next, the transaction verification part 120 determines the type of the transaction (step S202). If the type of the transaction is directly described in the transaction, the transaction verification part 120 may refer to this information. If the type of the transaction is not described, the transaction verification part 120 may determine the type of the transaction from what is described in the transaction. For example, when a code or a binary is included, the transaction verification part 120 may determine that the transaction is a contract. The transactions included in the block illustrated in FIG. 3 include their respective types. Thus, the transaction verification part 120 determines that the type of the transaction whose transaction ID is 1000 is a contract, the type of the transaction whose transaction ID is 1001 is input of a contract, and the type of the transaction whose transaction ID is 1002 is an execution result of a contract. If the type obtained as a result of the determination is a contract, the processing proceeds to step S203. If the type is an execution result of a contract, the processing proceeds to step S206. If the type is a different type, which is neither a contract nor an execution result of a contract (for example, if the type is input of a contract), the transaction verification part 120 may determine that the verification result is accurate without performing any verification. If there is another rule, the transaction verification part 120 may perform verification in accordance with the rule on this different type.

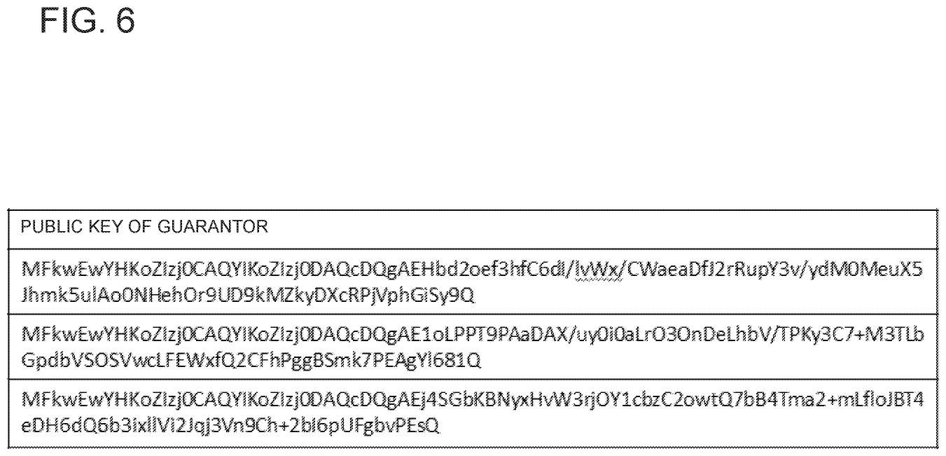

If the type of the transaction is a contract, the contract signature verification section 121 acquires a public key(s) of a guarantor(s) from the guarantor information storage section 122 (step S203). For example, as illustrated in FIG. 6, when three public keys of a guarantor are stored in the guarantor information storage section 122, the contract signature verification section 121 acquires all the public keys.

Next, the contract signature verification section 121 verifies a signature included in the transaction by using the public key(s) of the guarantor(s) (step S204). When there are a plurality of public keys of a guarantor(s), the contract signature verification section 121 may use only one of the public keys to verify the signature. When a plurality of signatures are included in the transaction, the contract signature verification section 121 may determine that the verification result is accurate if all the signatures have been verified by the respective public keys of the guarantor(s). Alternatively, the contract signature verification section 121 may determine that the verification result is accurate if only a predetermined number of signatures of all the plurality of signatures included in the transaction have been verified, even if one or more signatures have not been verified. In this example, since the transaction illustrated in FIG. 3 whose transaction ID is 1000 includes only one signature, the contract signature verification section 121 may determine that the verification result is accurate if the signature is verified by using any one of the three signatures stored in the guarantor information storage section 122. This example assumes that the signature has been verified by using the top public key in FIG. 6, which is “MFkwEwYHKoZIzjOCAQYIKoZIzjODAQcDQgAEHbd2oef3hfC6dI/lvW x/CWaeaDfJ2rRupY3v/ydMOMeuX5Jhmk5u1Ao0NHehOr9UD9kMZkyDX cRPjVphGiSy9Q”.

Next, if the signature has been verified as being accurate, the contract signature verification section 121 outputs a reply indicating that the verification result is accurate (step S205). As described above, since the contract signature verification section 121 has determined that the signature in the transaction whose transaction ID is 1000 in FIG. 3 is accurate, the contract signature verification section 121 outputs a reply indicating that the verification result is accurate.

If the type of the transaction is determined to be an execution result of a contract in step S202, the contract execution result verification section 123 determines the corresponding input of the contract and the corresponding contract from which the execution result of the contract has been derived (step S206). In this example, in the block illustrated in FIG. 3, the transaction whose transaction ID is 1002 is determined to be a transaction whose type is an execution result of a contract. Next, by referring to the transaction ID of the input included in this transaction, the contract execution result verification section 123 can acquire the transaction whose transaction ID is 1001 from the ledger storage part 140 or a block received by the block reception part 110. In this way, the contract execution result verification section 123 can acquire the input of the contract. In the transaction whose transaction ID is 1001, which is the transaction indicating the input of the acquired contract, a contract ID is written. By acquiring the contract whose contract ID is 10 from the ledger storage part 140 or a block received by the block reception part 110, the contract execution result verification section 123 can acquire the corresponding contract. In this example, the contract execution result verification section 123 acquires the contract registered with the transaction ID 1000. As described above, the input of the contract and the contract may be determined based on information about their respective identifiers. Alternatively, a specific value may be written along with the execution result of the contract. The determination method is not limited to any particular method.

Next, the contract execution result verification section 123 executes the contract by using the input of the contract and the contract (step S207). A script execution infrastructure may execute the contract registered as a code. Alternatively, the contract registered as a binary may be executed directly. Still alternatively, the contract may be executed on a virtual environment. Any execution method may be used. For example, assuming that the contract whose contract ID is 10 indicates conversion of the virtual currency possession amount inputted into a vote at a rate of 100:1, since the transaction whose transaction ID is 1001 indicates that virtual currency 100 of a user X is inputted as the input of the contract, the contract execution result verification section 123 gives a vote 1 to the user X. Thus, if the virtual currency possession amount of the user X is originally 1000, the virtual currency possession amount is reduced to 900. If the vote of the user X is originally 0, the vote is increased to 1.

Next, the contract execution result verification section 123 determines whether the execution result matches the execution result of the contract included in the transaction (step S208). For example, the contract execution result verification section 123 performs the above determination by checking whether the execution result calculated in step S207 matches the execution result written in the transaction whose transaction ID is 1002 illustrated in FIG. 3.

Finally, if the execution results match, the contract execution result verification section 123 outputs a reply indicating that the verification result is accurate (step S209).

Next, an example of an operation in which the consensus building part 130 performs consensus building will be described in detail with reference to a flowchart in FIG. 7. As an example according to the present exemplary embodiment, consensus building based on a scheme referred to as proof-of-work adopted in bitcoins will be described. However, another consensus building method may alternatively be used. Namely, the consensus building method is not limited to any particular method.

First, the consensus building part 130 acquires the hash value of the block (step S301). The consensus building part 130 may acquire the hash value for the entire block or for a value that summarizes a feature of the block. This example assumes that the hash value in the block illustrated in FIG. 3 is “0000000000000000000000000000000000000000000000002bcad85e7b4 0d3a4” when expressed in hexadecimal notation.

Finally, the consensus building part 130 determines whether the hash value of the block is smaller than a target value. If the hash value of the block is smaller than a target value, the consensus building part 130 determines that a consensus has been built (step S302). The target value may be a predetermined value unique to the system. Alternatively, the consensus building part 130 may generate the target value by performing calculation while referring to a block(s) in the past. This example assumes that the target value with respect to the block illustrated in FIG. 3 is “00000000000000000000000000000000000000000000000100000000000 00000”. Thus, since the above hash value of the block in FIG. 3 is smaller than the target value, the consensus building part 130 determines that a consensus has been built.

This consensus building method is referred to as proof-of-work, and when a block is generated, a value referred to as a nonce, such as one as illustrated in the block in FIG. 3, is changed, and a block is generated in such a manner that the hash value of the block becomes smaller than the target value. Since the nonce cannot be calculated from the hash value by an inverse operation, the nonce needs to be found in a round robin manner. Thus, generation of a block needs a certain calculation cost and time. The time that is needed to generate a block can be controlled based on the target value. For example, in bitcoins, the time that is needed to generate a future block(s) is adjusted to be about 10 minutes from the intervals at which some of the recent blocks have been generated. The consensus building part 130 using proof-of-work can verify whether a block has been generated with a certain calculation cost by using the hash value of the block. By causing most blockchain management apparatuses 100 participating in a blockchain network to verify the hash value of the block in accordance with the same rule and to determine that only the verified blocks as the blocks to be stored in their respective ledger storage parts 140, a consensus can be built on the entire network.

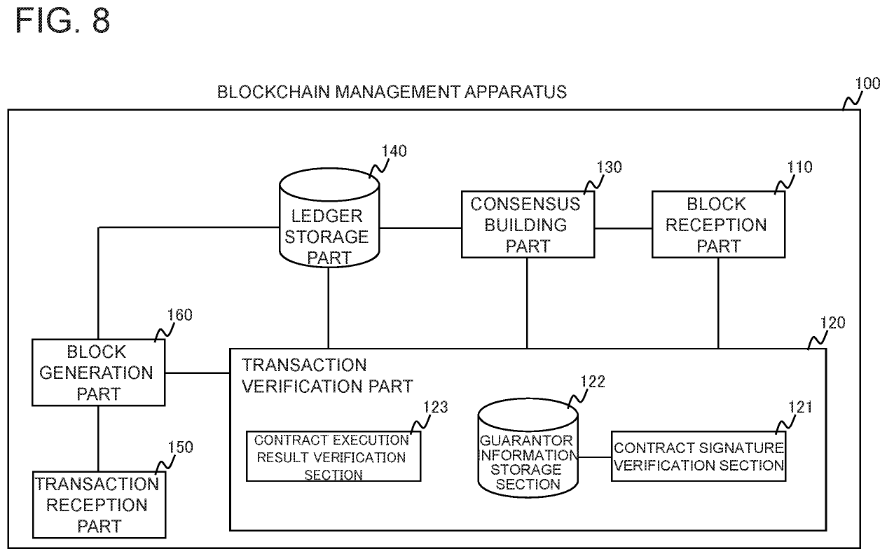

In addition, as illustrated in FIG. 8, the blockchain management apparatus 100 according to the present exemplary embodiment may include a transaction reception part 150 that receives a transaction(s) from a transaction issuer(s) or a different blockchain management apparatus(es) 100 and a block generation part 160 that generates a block(s) by grouping a hash value(s) calculated from a last block(s) stored in the ledger storage part 140 and the transaction(s) received. In addition, for consensus building based on the above proof-of-work, the block generation part 160 may include a function of generating a block that satisfies a certain condition. Namely, the block generation part 160 generates a block(s) in such a manner that a predetermined condition is satisfied when a hash value(s) calculated from a block(s) in accordance with a predetermined rule is compared with a target value(s) given to the system or calculated from a plurality of blocks stored in the ledger storage part 140.

Next, a hardware configuration of the blockchain management apparatus 100 according to the first exemplary embodiment will be described.

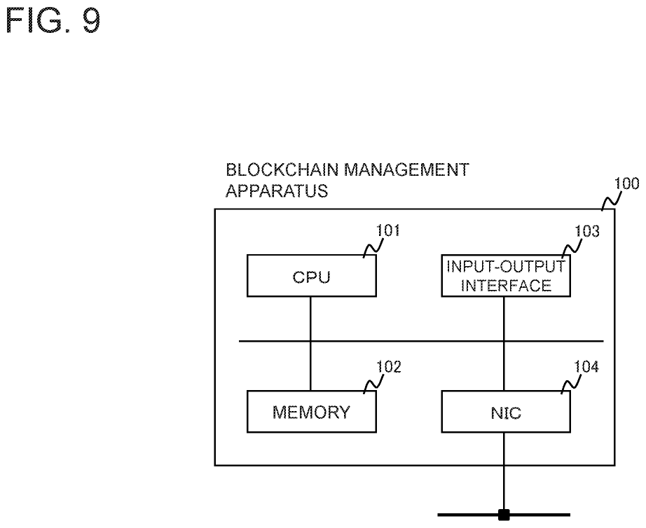

FIG. 9 is a block diagram illustrating an example of a hardware configuration of the blockchain management apparatus 100 according to the first exemplary embodiment. The blockchain management apparatus 100 can be configured by a so-called computer (an information processing apparatus) and has a configuration illustrated as an example in FIG. 9. For example, the blockchain management apparatus 100 includes a central processing unit (CPU) 101, a memory 102, an input-output interface 103, and a network interface card (NIC) 104 that serves as a communication interface, which are connected to each other via an internal bus.

However, the hardware configuration of the blockchain management apparatus 100 is not limited to the configuration illustrated in FIG. 9. The blockchain management apparatus 100 may include a hardware component not illustrated in FIG. 9 or may be configured without the input-output interface 103 as appropriate. In addition, for example, the number of CPUs included in the blockchain management apparatus 100 is not limited to the example in FIG. 9. For example, a plurality of CPUs may be included in the blockchain management apparatus 100.

The memory 102 is a random access memory (RAM), a read-only memory (ROM), or an auxiliary storage device (a hard disk, for example).

The input-output interface 103 is an interface connected to a display apparatus or an input apparatus not illustrated. The display apparatus is, for example, a liquid crystal display. The input apparatus is, for example, an apparatus that receives user operations such as a keyboard, a mouse, or the like or an apparatus that receives information from an external storage device such as a universal serial bus (USB) memory. The user inputs necessary information to the blockchain management apparatus 100 by using a keyboard, a mouse, or the like.

Functions of the blockchain management apparatus 100 are realized by the above processing modules. For example, these processing modules are realized by causing the CPU 101 to execute a program stored in the memory 102. In addition, the program can be updated by downloading an updated program via a network or using a storage medium in which an updated program is stored. In addition, the above processing modules may be realized by a semiconductor chip. Namely, functions of the above processing modules may be realized by some hardware and/or software. In addition, by installing the above computer program in a storage part in a computer, the computer can be caused to function as the blockchain management apparatus 100. In addition, by causing a computer to execute the above computer program, the computer can be caused to perform the blockchain management method.

Next, advantageous effect of the present exemplary embodiment will be described. As described above, with the blockchain management apparatus 100 according to the present exemplary embodiment, only the contracts verified by a guarantor(s) are registered on a blockchain. Namely, it is possible to provide a blockchain in which a contract(s) can be executed safely and securely without having contract users verify the contract(s).

The reason will be described as follows. First, in the blockchain management apparatus 100 according to the present exemplary embodiment, the contract signature verification section 121 of the transaction verification part 120 verifies a signature(s) added to a contract(s) by using a public key(s) of a guarantor(s) stored in the guarantor information storage section 122. Second, the consensus building part 130 performs consensus building with a different blockchain management apparatus(es) 100 only when the transaction verification part 120 has verified that all the transactions included in a block(s) received by the block reception part 110 are accurate. Since only the blocks about which consensus building has been reached are stored in the ledger storage part 140, a block(s) including a contract(s) without a signature(s) of a guarantor(s) is not stored in the ledger storage part 140.

The disclosure of the above NPL 1, etc. is incorporated herein by reference thereto. Variations and adjustments of the exemplary embodiment(s) and examples are possible within the scope of the overall disclosure (including the claims) of the present invention and based on the basic technical concept of the present invention. Various combinations and selections of various disclosed elements (including the elements in the claims, exemplary embodiment(s), examples, drawings, etc.) are possible within the scope of the claims of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

100 blockchain management apparatus
101 CPU (central processing unit)
102 memory
103 input-output interface
104 NIC (network interface card)
110 block reception part
120 transaction verification part
121 contract signature verification section
122 guarantor information storage section
123 contract execution result verification section
130 consensus building part
140 ledger storage part
150 transaction reception part
160 block generation part

What is claimed is:

1. A blockchain management apparatus, comprising:
a block reception part that receives a block(s) including a transaction(s) including at least one of a contract(s), input to a contract(s), and an execution result(s) of a contract(s);
a transaction verification part that verifies that the transaction(s) included in the block(s) is valid;
a consensus building part that builds a consensus(es) about writing of the block(s) with a different blockchain management apparatus(es) when the transaction verification part has verified that the transaction(s) included in the block(s) is valid; and
a ledger storage part that stores the block(s) about which the consensus(es) has been built;
wherein the transaction verification part includes: a guarantor information storage section that stores a public key(s) of a guarantor(s) who assures security of a contract(s);
a contract signature verification section that verifies, when the transaction(s) includes a contract(s), a signature(s) included in the transaction(s) by using a public key(s) of a guarantor(s) stored in the guarantor information storage section; and
a contract execution result verification section that verifies that, when the transaction(s) includes an execution result(s) of a contract(s), the execution result(s) of the contract(s) included in the transaction(s) is accurate with respect to the corresponding contract(s) and corresponding input of the contract(s).

2. The blockchain management apparatus according to claim 1; wherein the consensus building part compares a hash value(s) calculated from the received block(s) in accordance with a predetermined rule with a target value(s) given to a system or calculated from a plurality of blocks stored in the ledger storage part and determines that, when a result(s) of the comparison satisfies a predetermined condition, a consensus(es) has been built with a different blockchain management apparatus(es).

3. The blockchain management apparatus according to claim 1; wherein the contract execution result verification section acquires, by using an identifier(s) of the contract(s) or an identifier(s) of the input of the contract(s) described in the transaction(s), the contract(s) and the input of the contract(s) corresponding to the execution result(s) of the contract(s) from the received block(s) or the ledger storage part and executes the contract(s) by using the corresponding contract(s) and the corresponding input of the contract(s).

4. The blockchain management apparatus according to claim 1, further comprising:
a transaction reception part that receives a transaction(s); and
a block generation part that generates a block(s) by grouping a hash value(s) calculated from a last block(s) stored in the ledger storage part and the transaction(s) received by the transaction reception part.

5. The blockchain management apparatus according to claim 4; wherein the block generation part generates a block(s) in such a manner that a predetermined condition is satisfied when a hash value(s) calculated from a block(s) in accordance with a predetermined rule is compared with a target value(s) given to a system or calculated from a plurality of blocks stored in the ledger storage part.

6. A blockchain management method, comprising:
(1) receiving a block(s) including a transaction(s) including at least one of a contract(s), input to a contract(s), and an execution result(s) of a contract(s);
(2) verifying that the transaction(s) included in the block(s) is valid;
(3) building a consensus(es) about writing of the block(s) with a different blockchain management apparatus(es) when the transaction(s) included in the block(s) has been verified as being valid; and
(4) storing the block(s) about which the consensus(es) has been built in a ledger storage part;
wherein the (2) includes:
(5) verifying, when the transaction(s) includes a contract(s), a signature(s) included in the transaction(s) by using a public key(s) of a guarantor(s) stored in a guarantor information storage section that stores a public key(s) of a guarantor(s) who assures security of a contract(s); and
(6) verifying that, when the transaction(s) includes an execution result(s) of a contract(s), the execution result(s) of the contract(s) included in the transaction(s) is accurate with respect to the corresponding contract(s) and corresponding input of the contract(s).

7. The blockchain management method according to claim 6; wherein the (3) includes:
comparing a hash value(s) calculated from the received block(s) in accordance with a predetermined rule with a target value(s) given to a system or calculated from a plurality of blocks stored in the ledger storage part and,
determining that a consensus(es) has been built with a different blockchain management apparatus(es) when a result(s) of the comparison satisfies a predetermined condition.

8. The blockchain management method according to claim 6; wherein the (6) includes:
acquiring the contract(s) and the input of the contract(s) corresponding to the execution result(s) of the contract(s) from the received block(s) or the ledger storage part by using an identifier(s) of the contract(s) or an identifier(s) of the input of the contract(s) described in the transaction(s) and,
executing the contract(s) by using the corresponding contract(s) and the corresponding input of the contract(s).

9. The blockchain management method according to claim 6, further comprising:
receiving a transaction(s); and
generating a block(s) by grouping a hash value(s) calculated from a last block(s) stored in the ledger storage part and the transaction(s) received.

10. A non-transitory computer-readable storage medium storing a program, causing a computer to execute processing for:
(1) receiving a block(s) including a transaction(s) including at least one of a contract(s), input to a contract(s), and an execution result(s) of a contract(s);
(2) verifying that the transaction(s) included in the block(s) is valid;
(3) building a consensus(es) about writing of the block(s) with a different blockchain management apparatus(es) when the transaction(s) included in the block(s) has been verified as being valid; and
(4) storing the block(s) about which the consensus(es) has been built in a ledger storage part;
wherein the processing for verifying that the transaction(s) is valid includes:
(5) verifying, when the transaction(s) includes a contract(s), a signature(s) included in the transaction(s) by using a public key(s) of a guarantor(s) stored in a guarantor information storage section that stores a public key(s) of a guarantor(s) who assures security of a contract(s); and
(6) verifying that, when the transaction(s) includes an execution result(s) of a contract(s), the execution result(s) of the contract(s) included in the transaction(s) is accurate with respect to the corresponding contract(s) and corresponding input of the contract(s).

11. The non-transitory computer-readable storage medium storing a program according to claim 10; wherein the (3) includes:
comparing a hash value(s) calculated from the received block(s) in accordance with a predetermined rule with a target value(s) given to a system or calculated from a plurality of blocks stored in the ledger storage part and,
determining that a consensus(es) has been built with a different blockchain management apparatus(es) when a result(s) of the comparison satisfies a predetermined condition.

12. The non-transitory computer-readable storage medium storing a program according to claim 10; wherein the (6) includes:
acquiring the contract(s) and the input of the contract(s) corresponding to the execution result(s) of the contract(s) from the received block(s) or the ledger storage part by using an identifier(s) of the contract(s) or an identifier(s) of the input of the contract(s) described in the transaction(s) and,
executing the contract(s) by using the corresponding contract(s) and the corresponding input of the contract(s).

13. The non-transitory computer-readable storage medium storing a program according to claim 10, further comprising:
receiving a transaction(s); and
generating a block(s) by grouping a hash value(s) calculated from a last block(s) stored in the ledger storage part and the transaction(s) received.
